(19) United States
(12) Patent Application Publication
(10) Pub. No.: US 2022/0009177 A1
(43) Pub. Date: Jan. 13, 2022

(54) METHOD FOR PREPARING A POLYURETHANE COMPOSITE BY VACUUM INFUSION PROCESS

(71) Applicant: Covestro Intellectual Property GmbH & Co. KG, Leverkusen (DE)

(72) Inventors: Yongming Gu, Pudong New District (CN); Di Wu, Pudong New District, Shanghai (CN); Ian Zheng, Zhujing Town, Jinshan District, Shanghai (CN); Xiaojun Han, Xuhui District Shanghai (CN); Hui Zhang, Zhujing Town, Jinshan District, Shanghai (CN); Hao Cheng, Baoshan District, Shanghai (CN)

(21) Appl. No.: 17/295,514

(22) PCT Filed: Dec. 11, 2019
(86) PCT No.: PCT/EP2019/084662

§ 371 Date: May 20, 2021

(30) Foreign Application Priority Data
Dec. 19, 2018 (CN) 201811577517.1
Jan. 29, 2019 (EP) 19154078.0

(51) Int. Cl. B29C 70/44; B29C 70/54

(52) U.S. Cl. CPC B29C 70/44; B29K 2075/00; B29C 70/54

(57) ABSTRACT

The invention relates to a method for preparing a polyurethane composite by vacuum infusion process, the composite prepared by the method and use thereof. The method according to the present invention preferably comprises the use of a polyester peel ply having a specific gram weight, a reinforced material and/or a porous medium, and the like. The polyurethane composite produced by the method according to the present invention has both good physical properties and a satisfactory outer surface without the need to separately treat the outer surface.

The invention relates to a method for preparing a polyurethane composite by vacuum infusion process, the composite prepared by the method and use thereof.

Polyurethane composites are widely used in various fields such as pultruded window frames, home appliance furniture and fan blades. In recent years, the superiority of polyurethane composites in the preparation of fan blades has received increasing attention. Wind energy is considered to be one of the cleanest and most environmentally friendly energy sources available today. Therefore, wind turbines have always been demanded by the market. Compared with conventional epoxy resin-made fan blades, fan blades made of polyurethane composites have the advantages of lower cost and better mechanical properties. However, polyurethane is sensitive to water, and the peel ply useful in the preparation of polyurethane composites usually contains a certain amount of water. How to reduce the water content of the peel ply and other raw materials has been thus a difficult problem in the industry.

WO2007038930A1 discloses a RTM method of producing a fiber-reinforced product which method comprises the steps of: a) placing at least one porous member (104) in a mold (103); b) placing one or more layer(s) of reinforcing fibers (102) in the mold; c) introducing resin for distribution through the porous member to the fiber layers, and d) allowing the resin to cure and the distribution member to coalesce to form a continuous layer, as well as the produced fiber-reinforced composites.

CN102632622A discloses a fiber reinforced resin-based composite furniture material and a preparation method thereof, which solve the technical problems of the prior materials. It makes use of a thermosetting resin as a matrix, a woven fiber as a reinforced material, and a core material as an intermediate layer. This material can be widely used in the manufacture of furniture.

CN103260860A discloses a vacuum-assisted resin transfer molding (VARTM) method, the method comprising: providing a vacuum-assisted resin transfer mold assembly comprising a mold having a first mold surface and a second mold surface arranged to enclose a laminate assembly within a space between the first and second mold surfaces when the laminate assembly is placed on the first mold surface; providing a laminate assembly and corresponding parts and materials to produce an resin article by the VARTM method.

Despite the above disclosure, there is an urgent need for a more efficient and superior method of producing polyurethane composites in the market.

In one aspect of the invention, there is provided a method for preparing a polyurethane composite by vacuum infusion process, comprising the steps of:

placing one or more layers of reinforced material in a mold;

placing at least one polyester peel ply having a gram weight of 50 g/m² to 150 g/m², preferably 80 g/m² to 100 g/m² in the mold;

introducing and curing a polyurethane resin to obtain the polyurethane composite.

Preferably, the method according to the present invention further comprises the step of placing a core material in the mold prior to introducing the polyurethane resin.

Preferably, the polyester peel ply is selected from the group consisting of plain cloth, twill cloth, satin cloth made of continuous fibers by a weaving method or fabric made of continuous fibers by a knitting method or fabric made of continuous fibers directly by a stitch-bonding method. The polyester peel ply may be placed between the reinforced material and the mold, or, in the presence of a core material or a porous part, between the reinforced material and/or the core material and the porous part (for example, a flow mesh).

Preferably, the core material is selected from the group consisting of balsa wood, PVC foam, SAN foam, polyurethane foam, PS foam, PMI foam, and PET foam.

Preferably, at least one porous structural part is placed to the uppermost or lowermost layer of the layers (for example, the reinforced material layer and the peel ply and the like) placed inside the mold prior to introducing the polyurethane resin. The porous part, which may also be referred to as a porous material, refers to a material having a network structure formed by pores that penetrate each other.

Preferably, the method according to the present invention further comprises the step of peeling off the peel ply and the porous structural part after curing the polyurethane resin.

Preferably, the reinforced material is preferably a glass fiber floss layer, a glass fiber fabric and a glass fiber gauze, cut or ground glass fibers or mineral fibers, and a fiber mat, a fiber nonwoven and a fiber knit based on polymer fibers, mineral fibers, carbon fibers, glass fibers or aramid fibers, and mixtures thereof, more preferably a glass fiber mat or a glass fiber nonwoven.

Preferably, the reinforced material is a fiber reinforced material having a water content of <0.1 wt %, preferably <0.09 wt %, and particularly preferably 0.01 to 0.05 wt %, based on the total weight of the fiber reinforced material.

Preferably, the method according to the present invention further comprises the following steps:

prior to introducing the polyurethane resin, a layer of film is placed over the layers arranged in the mold, and the periphery of the film is sealed with the mold, and the film is tightened by using a vacuum pump. Then, a second layer of film is placed thereon and fixed, and the first layer of film and the second layer of film are sealed at their periphery and the air inlet and outlet channels are reserved. The mold is heated while filling hot air between the first layer of film and the second layer of film to provide a temperature close to the mold temperature to the upper surface of the first layer of film.

One preferred embodiment of the method comprises the further step of drying the layers and the parts arranged in the mold before introduction of the reactive mixture of the polyurethane resin.

Through experiments, it has surprisingly found that the method according to the present invention provides more preferable raw materials such as a polyester peel ply having a lower water content, effectively reduces the temperature for drying raw materials such as the peel ply and the fiber reinforced material, shortens the drying time, effectively removes the surface defects of the obtained polyurethane composite, and obtains a polyurethane composite with excellent physical properties and satisfactory surface condition. The method according to the present invention effectively improves the production efficiency and quality of the polyurethane composite and thereby saves the cost.

In one exemplary embodiment of the inventive method, a vacuum infusion device according FIG. 3 is used and the method comprises the following steps:

one or more layers of reinforced material are placed in a mold;

at least one polyester peel ply having a gram weight of 50 g/m² to 150 g/m², preferably 80 g/m² to 100 g/m² is placed in the mold;

optionally further parts or material are placed in the mold;

at least one film is placed over the layers and optionally the parts and other material arranged in the mold and the periphery of the film(s) is sealed with the mold;

a reaction injection device (40) is connected with an injection line (45) to a first injection port (31) in the mold, and the injection line (45) may advantageously comprise a laterally closable outlet (46) connected to a vacuum source (47);

the mold (5) including the layers and parts arranged therein (21), the injection line (45), as well as optionally the reaction injection device may then be dried via the vacuum source (47) and the dry channel (32), which may be used either for evacuation of the mold (5) with the vacuum source (34) or for providing a drying gas;

the polyurethane resin is then introduced as reactive mixture into the mold (5) by the reaction injection device via injection line (45) through the injection port (31), while the mold (5) is evacuated by the vacuumizing source (34) via the dry channel (32),

and the polyurethane composite is cured in the mold (5) preferably under heating.

The reaction injection device (40) preferably comprises at least two storage tanks (48, 49) for accommodating components of the polyurethane resin, a vacuum device (50) and metering devices (44a, 44b), each metering device (44a, 44b) being connected with the storage tank (48, 49) through a feed line (41, 42) and a mixing unit (43), wherein the components from the feed units (44a, 44b) are mixed together.

When starting the injection of the polyurethane resin from the components by introducing the degassed components from the storage tanks (48, 49) via the injection lines (41, 42), the feed units (44a, 44b) and the mixing unit (43) into the injection line (45), the outlet (46) of the vacuum source (47) needs to be closed before the polyurethane resin arrives.

In another aspect of the invention, there is provided a polyurethane composite obtained by the method according to the present invention for preparing a polyurethane composite by vacuum infusion process. In a further aspect of the invention, there is provided the use of a polyurethane composite according to the present invention in a turbine fan blade.

In a further aspect of the invention, there is provided a polyurethane product comprising a polyurethane composite obtained by the method according to the present invention for preparing a polyurethane composite by vacuum infusion process.

Preferably, the polyurethane product is selected from the group consisting of a turbine fan blade, a radome, a single-layer or sandwich sheet, preferably a spar cap, a shear web, a blade root and/or a blade shell of a turbine fan blade.

### DESCRIPTION OF FIGURES

The invention will now be described by way of example with reference to the accompanying figures in which:

FIG. 1 shows the mold used in the method for producing a polyurethane composite according to the present invention and the layers arranged thereon, wherein 1 represents the reinforced material layer(s); 2 represents the injection line; 3 represents the peel ply and the porous structural layer; 4 represents the pumping line; and 5 represents the mold.

FIG. 2 shows the surface condition of the polyurethane composite obtained by introducing a polyurethane resin after vacuum dehumidification at 35° C. for 0.5 hour, wherein the left one is Comparative Example 1, and the right one is Example 1.

FIG. 3 shows the reaction injection device 40 and the mold according to invention preferred embodiment, wherein 5 represents the mold; 21 represents the reinforced material layer and the peel ply; 31 represents the first injection port; 32 represents the dry channel; 41, 42 represent the feed lines; 43 represents the mixing unit; 44a, 44b represent the feed units; 45 represents the injection line; 46 represents the closable outlet; 47 represents the vacuumizing source; 48, 49 represent the storage tanks; and 50 represents the vacuumizing device.

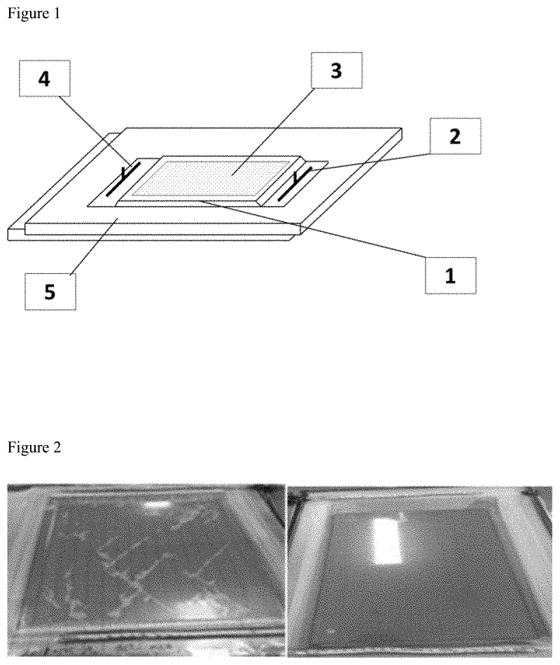

Various aspects of the invention are now described in detail.

According to a first aspect of the invention, there is provided a method for preparing a polyurethane composite by vacuum infusion process, comprising the steps of:

placing one or more layers of reinforced material in a mold;

placing at least one polyester peel ply having a gram weight of 50 g/m² to 150 g/m², preferably 80 g/m² to 100 g/m² in the mold;

introducing and curing a polyurethane resin to obtain the polyurethane composite.

The polyester peel ply useful in the present invention refers to a peel ply made of polyester fibers. Polyester fibers (PET fibers, commonly known as “dacron”) refers to the general fibers made from polyester(s) produced by polycondensation of various diols and aromatic dicarboxylic acids or their esters as the raw material.

Preferably, the polyester peel ply is selected from the group consisting of plain cloth, twill cloth, satin cloth made of continuous fibers by a weaving method or fabric made of continuous fibers by a knitting method or fabric made of continuous fibers directly by a stitch-bonding method.

The polyester peel ply may be placed between the reinforced material and the mold, or between the reinforced material and/or the core material and the porous part (for example, a flow mesh). The porous part, which may also be referred to as a porous material, refers to a material having a network structure formed by pores that penetrate each other. Its structure may be a three-dimensional structure formed by a large number of polyhedral shaped pores gathered in space. The porous part useful in the present invention is preferably a flow guiding medium. The flow guiding medium refers to a substance having a porous structure, which may be a material obtained by plaiting, weaving, knitting, extruding or crocheting, a foam or a substance as such having a sieve or mesh structure. Specifically, it includes, but is not limited to, woven flow mesh, pressed flow mesh, continuous fiber mat; and hybrid flow mesh, which is, for example, prepared by mixing two or more of the woven infusion net, the pressed flow mesh, the fiber fabrics such as a continuous mat and a short-cut mat. It is well-known for those skilled in the art that materials that can be used as a flow guiding medium include, but are not limited to, polystyrene (PS), polyurethane (PUR), polyphenylene oxide (PPO), polypropylene, ABS, and glass fiber fabrics, and the like. The substance having a porous structure preferably has an area density of 100 g/m² to 500 g/m². The porous part or flow guiding medium is mainly used to aid in vacuumizing during the drying process and guiding flow during the introduction of the liquid polyurethane material.

The mold useful in the present invention includes, but is not limited to, that of a fan blade and/or component thereof, an aircraft and/or component thereof, a hull and/or component thereof, a vehicle body and/or component thereof, and the like. In an embodiment of the invention, the mold is preferably a mold that can be used to make a fan blade and/or component thereof in a polyurethane vacuum infusion process. The mold may include a heating function.

In an embodiment of the invention, the method according to the present invention heats the peel ply, the fiber reinforced material, the porous part and/or the core material in a manner selected from one, two or more of mold heating, electric blanket heating, electric film heating, microwave heating, infrared heating and hot air heating. The electric blanket heating or the electric film heating refers to the heating by supplying current to an electric blanket or an electric film placed under the mold or covering the film outside. Other conventional heating methods in the art can also be used in the present invention.

Preferably, it further comprises the step of placing a core material in the mold prior to introducing the polyurethane resin. Preferably, the core material is selected from the group consisting of balsa wood, PVC foam, SAN foam, polyurethane foam, PS foam, PMI foam, and PET foam.

Preferably, at least one porous structural part is placed to the uppermost or lowermost layer of the layers (for example, the reinforced material layer and the peel ply and the like) placed inside the mold prior to introducing the polyurethane resin.

Preferably, it further comprises the step of peeling off the peel ply and the porous structural part after curing the polyurethane resin.

Preferably, the reinforced material is preferably a glass fiber floss layer, a glass fiber fabric and a glass fiber gauze, cut or ground glass fibers or mineral fibers, and a fiber mat, a fiber nonwoven and a fiber knit based on polymer fibers, mineral fibers, carbon fibers, glass fibers or aramid fibers, and mixtures thereof, more preferably a glass fiber mat or a glass fiber nonwoven.

Preferably, the reinforced material is a fiber reinforced material having a water content of <0.1 wt %, preferably <0.09 wt %, and particularly preferably 0.01 to 0.05 wt %, based on the total weight of the fiber reinforced material. In certain embodiments of the invention, the selected glass fiber cloth has a water content of <0.1 wt %, and is dehumidified by vacuum to have a water content of 0.01 to 0.05 wt %.

Preferably, the method according to the present invention further comprises the following steps:

prior to introducing the polyurethane resin, a layer of film is placed over the layers arranged in the mold, and the periphery of the film is sealed with the mold, and the film is tightened by using a vacuum pump. Then, a second layer of film is placed thereon and fixed, and the first layer of film and the second layer of film are sealed at their periphery and the air inlet and outlet channels are reserved. The mold is heated while filling hot air inbetween the first layer of film and the second layer of film to provide a temperature close to the mold temperature to the upper surface of the first layer of film.

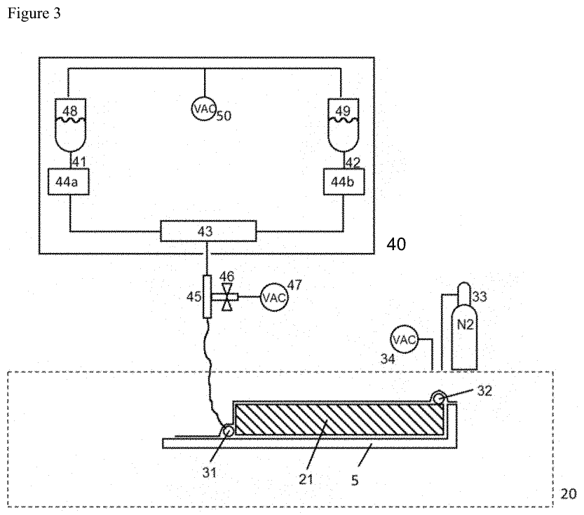

In one exemplary embodiment of the inventive method, a vacuum infusion device according FIG. 3 is used and the method comprises the following steps:

one or more layers of reinforced material are placed in a mold;

at least one polyester peel ply having a gram weight of 50 g/m² to 150 g/m², preferably 80 g/m² to 100 g/m² is placed in the mold;

optionally further parts or material are placed in the mold;

at least one film is placed over the layers and optionally the parts and other material arranged in the mold and the periphery of the film(s) is sealed with the mold;

a reaction injection device (40) is connected with an injection line (45) to a first injection port (31) in the mold, and the injection line (45) may advantageously comprise a laterally closable outlet (46) connected to a vacuum source (47);

the mold (5) including the layers and parts arranged therein (21), the injection line (45), as well as optionally the reaction injection device may then be dried via the vacuum source (47) and the dry channel (32), which may be used either for evacuation of the mold (5) with the vacuum source (34) or for providing a drying gas;

the polyurethane resin is then introduced as reactive mixture into the mold (5) by the reaction injection device via the injection line (45) through the injection port (31), while the mold (5) is evacuated by the vacuumizing source (34) via the dry channel (32),

and the polyurethane composite is cured in the mold (5) preferably under heating.

The experimental results show that the method according to the present invention provides more preferable raw materials such as a polyester peel ply having a lower water content, effectively reduces the temperature for drying raw materials such as the peel ply and the fiber reinforced material, shortens the drying time, and obtains a polyurethane composite with excellent physical properties and satisfactory surface condition. The method according to the present invention effectively improves the production efficiency and surface quality of the polyurethane composite and thereby saves the cost.

According to another aspect of the invention, there is provided a polyurethane composite obtained by the method according to the present invention for preparing a polyurethane composite by vacuum infusion process.

In certain embodiments, the polyurethane composite according to the present invention not only has good physical properties, but also is free of surface defects. It facilitates further processing, and is very suitable for the use in large-scale polyurethane products.

In a further aspect of the invention, there is provided the use of a polyurethane composite according to the present invention in a turbine fan blade.

In a further aspect of the invention, there is provided a polyurethane product comprising a polyurethane composite obtained by the method according to the present invention for preparing a polyurethane composite by vacuum infusion process.

Preferably, the polyurethane product is selected from the group consisting of a turbine fan blade, a radome, a single-layer or sandwich sheet, preferably a spar cap, a shear web, a blade root and/or a blade shell of a turbine fan blade.

All technical and scientific terms used herein have the same meaning as commonly understood by those skilled in the art to which the present invention belongs, unless otherwise defined. When the definition of a term in the present description conflicts with the meaning as commonly understood by those skilled in the art to which the present invention belongs, the definition described herein shall apply.

All numerical values expressing amount of ingredients, reaction conditions and the like which are used in the description and claims are to be understood as being modified by the term “about”, unless otherwise specified.

The term “and/or” used herein refers to one or all of the elements mentioned.

The terms “including” and “comprising” used herein cover both the case that there are only the elements mentioned and the case that there are also other elements unmentioned in addition to the elements mentioned.

All percentages in the present invention refer to weight percentage, unless otherwise specified.

The invention is now described by way of examples for the purpose of illustration and not limitation.

### EXAMPLES

Material Description:

Polyester peel ply (gram weight: 95 g/m²): purchased from LEADGO-TECH Co., Ltd.;

Nylon peel ply (gram weight: 80 g/m²): purchased from LEADGO-TECH Co., Ltd.;

Film: having a thickness of 50 μm, purchased from LEADGO-TECH Co., Ltd.;

Rubber strip (brand: WD209): purchased from Shanghai Kangda New Materials Co., Ltd.;

Glass fiber cloth (biaxial cloth, having a water content of <0.1 wt %): purchased from Chongqing Polycomp International Corp.;

Insulation blanket (specification: a width of 1 m, a length of 2 m, a thickness of 30 mm): purchased from the relevant market;

flow mesh: purchased from the relevant market;

Polyurethane resin (raw material brand: Baydur 78BD085 and Desmodur 44CP20): purchased from Covestro Polymers (China) Co., Ltd.

Test Method Description:

The gram weight of a peel ply: that is the weight per unit area, specifically the value obtained from the weight of a peel ply divided by its area.

Water content: it is (W1-W2)/W1, wherein W1 is the weight directly after sampling and W2 is the weight after oven drying.

Temperature test: the surface temperature is monitored using an infrared thermometer.

### EXAMPLES

Preparation of Polyurethane Composites of the Inventive and Comparative Examples:

### Example 1 and Comparative Example 1

A glass fiber cloth, a polyester peel ply (a nylon peel ply in Comparative Example 1), a flow mesh and a layer of film were laid on a mold. The periphery of the film was sealed with the mold, and the film was tightened by using a vacuum pump. The mold was heated and the heating was stopped after 0.5 hour. After cooling to room temperature, the polyurethane resin was injected and cured to obtain the polyurethane composite (the surface condition of Comparative Example 1 is shown in the left diagram of FIG. 2, and the surface condition of Example 1 is shown in the right diagram of FIG. 2).

The experimental results illustrate that, as shown in the figure, under the same dehumidification conditions, the surface of the polyurethane composite using the polyester peel ply has almost no defect, reflecting that the use of a polyester peel ply can improve the dehumidification efficiency; while under the same conditions the surface defects of the polyurethane composite using the nylon peel ply are very obvious, indicating that the dehumidification efficiency is low and a higher temperature or a prolonged dehumidification time is required. A higher temperature mean that it takes longer to cool down to room temperature, which is a great challenge for production efficiency. The method for preparing a polyurethane composite according to the present invention successfully overcomes the disadvantage of polyurethane's sensitivity to water, and obtains a polyurethane composite with superior physical properties and surface quality, so that the polyurethane composites are now applicable in some large-scale articles such as fan blades and therefore it promotes the development of related environmental protection industries.

Although the invention has been described in detail above with respect to the object of the present invention, it should be understood that this detailed description is only exemplary. Besides the subject-matters claimed in the claims, various changes may be made by those skilled in the art without departing from the spirit and scope of the invention.

1. A method for preparing a polyurethane composite by a vacuum infusion process, comprising:
placing one or more layers of reinforced material in a mold;
placing at least one polyester peel ply having a gram weight of 50 g/m² to 150 g/m² in the mold;
introducing a polyurethane resin in the mold and curing the polyurethane resin to obtain the polyurethane composite.

2. The method according to claim 1, wherein the polyester peel ply comprises plain cloth, twill cloth, satin cloth made of continuous fibers by a weaving method or fabric made of continuous fibers by a knitting method or fabric made of continuous fibers directly by a stitch-bonding method.

3. The method according to claim 1, further comprising placing a core material in the mold prior to introducing the polyurethane resin.

4. The method according to claim 3, wherein the core material is selected from the group consisting of balsa wood, PVC foam, SAN foam, polyurethane foam, PS foam, PMI foam, and PET foam.

5. The method according to claim 1, wherein at least one porous structural part is placed as an uppermost or lowermost layer of the one or more layers of reinforced material and the peel ply prior to introducing the polyurethane resin.

6. The method according to claim 5, further comprising peeling off the polyester peel ply and the porous structural part after curing the polyurethane resin.

7. The method according to claim 1, wherein the reinforced material is a fiber reinforced material having a water content of <0.1 wt %, based on a total weight of the fiber reinforced material.

8. The method according to claim 1, wherein the reinforced material comprises a glass fiber floss layer, a glass fiber fabric, a glass fiber gauze, cut or ground glass fibers or mineral fibers, a fiber mat, a fiber nonwoven or a fiber knit based on polymer fibers, mineral fibers, carbon fibers, glass fibers or aramid fibers, or mixtures thereof.

9. The method according to claim 1, further comprising, prior to introducing and curing the polyurethane resin,
placing a layer of film over the layers arranged in the mold, sealing the periphery of the film with the mold, and tightening the film using a vacuum pump, then
placing and fixing a second layer of film thereon, sealing the first layer of film and the second layer of film at their periphery with air inlet and outlet channels reserved, then
heating the mold, and
filling hot air between the first layer of film and the second layer of film to provide a temperature close to a mold temperature to an upper surface of the first layer of film.

10. The method according to claim 1, further comprising:
placing at least one film over the layers and optionally the parts and other material arranged in the mold and sealing the periphery of the film(s) with the mold;
connecting a reaction injection device with an injection line to a first injection port in the mold, the injection line comprising a laterally closable outlet connected to a vacuum source;
drying the mold including the layers and parts arranged therein, the injection line, as well as optionally the reaction injection device via the vacuum source and a dry channel;
introducing the polyurethane resin as a reactive mixture into the mold by the reaction injection device via the injection line through the first injection port while the mold is evacuated by a vacuumizing source via the dry channel,
and curing the polyurethane composite in the mold.

11. A polyurethane composite obtained by the method according to claim 1.

12. A method of manufacturing a turbine fan blade, comprising: forming at least a portion of the turbine fan blade with the polyurethane composite obtained by the method according to claim 1.

13. A polyurethane product comprising a polyurethane composite obtained by the method according to claim 1.

14. The polyurethane product according to claim 13, wherein the polyurethane product is selected from the group consisting of a turbine fan blade, a radome, and a single-layer or sandwich sheet.
